(19) United States
(12) Patent Application Publication
(10) Pub. No.: US 2016/0004999 A1
(43) Pub. Date: Jan. 7, 2016

(54) DATA MANAGEMENT SYSTEM AND USER ACCESS SYSTEM FOR SOLICITING FINANCING FOR REAL ESTATE PROJECTS

(71) Applicant: Crowdedbuildings, LLC, St. Louis, MO (US)

(72) Inventors: Anthony Joseph Chivetta, III, St. Louis, MO (US); Maria Key Desloge, St. Louis, MO (US); William Florent, St. Louis, MO (US)

(21) Appl. No.: 14/321,621

(22) Filed: Jul. 1, 2014

(51) Int. Cl. G06Q 10/10; G06Q 30/02; G06F 17/30

(52) U.S. Cl. CPC G06Q 10/103; G06F 17/30598; G06F 17/30867; G06Q 40/06; G06Q 30/0277; G06Q 50/16

(57) ABSTRACT

A system for soliciting financing for real estate projects includes a data management system and a user access system. The data management system is configured to identify a project category for a real estate project based on preliminary project data provided by a project sponsor associated with the real estate project, select a project profile template from a plurality of project profile templates based on the identified project category, transmit a set of category-specific prompts to the project sponsor based on the identified project category, receive category-specific project data from the project sponsor, and generate a project profile for the real estate project by populating the selected project profile template with the category-specific project data. The user access system is configured to display the project profile to a potential investor.

### BACKGROUND OF THE DISCLOSURE

The field of the disclosure relates generally to real estate investing, and more particularly, to systems and methods for soliciting financing for real estate projects using an online environment that enables a plurality of potential investors to locate, analyze, compare, and purchase an interest in real estate projects.

Investing in real estate, such as commercial real estate, is often desirable for investors for a variety of reasons, such as diversifying their investment portfolio. Although desirable, investing in real estate is often impractical for non-institutional investors because of the time and cost associated with locating investment opportunities and minimum capital investment requirements. Additionally, it is often difficult for non-controlling shareholders of a real estate investment or project to liquidate their interest in the real estate project due to a lack of an established “market” for shares of the real estate project.

Further, sponsors of real estate projects often have restricted access to capital needed to finance such real estate projects. For example, banks and other lending institutions typically only lend a portion of the capital needed to finance commercial real estate projects. As a result, the project sponsors of such real estate projects must locate other sources of capital, such as other business partners.

Some known real estate investment systems allow sponsors of real estate projects to list their real estate projects on an online platform, and enable potential investors to view and invest in real estate projects listed on the online platform. Typically, the sponsor of the real estate project determines what information is included in the listing on such systems, and the manner in which the information is presented or displayed to potential investors. As a result, real estate project listings on such systems are typically presented in an inconsistent manner, making comparison of different real estate projects difficult, if not impossible for potential investors. Further, known real estate investment systems do not facilitate providing liquidity to investors of real estate projects on such systems.

### BRIEF DESCRIPTION OF THE DISCLOSURE

In one aspect, a system for soliciting financing for real estate projects is provided. The system includes at least one processor communicatively coupled to at least one memory, a data management system communicatively coupled to the at least one processor and the at least one memory, and a user access system communicatively coupled to the at least one processor and the at least one memory. The data management system is configured to identify a project category for a real estate project based on preliminary project data provided by a project sponsor associated with the real estate project, and select a project profile template from a plurality of project profile templates stored in the at least one memory based on the identified project category, where each project profile template associated with one of a plurality of project categories. The data management system is further configured to transmit a set of category-specific prompts to the project sponsor based on the identified project category, wherein the set is one of a plurality of sets of category-specific prompts stored in the at least one memory, and each set is associated with one of the project categories. The data management system is further configured to receive category-specific project data from the project sponsor, and generate a project profile for the real estate project by populating the selected project profile template with the category-specific project data using the at least one processor. The user access system is configured to display the project profile to a potential investor.

In another aspect, a computer-based method for soliciting financing for real estate projects is provided. The method is implemented using a computing device including at least one processor communicatively coupled to at least one memory, a data management system communicatively coupled to the at least one processor and the at least one memory, and a user access system communicatively coupled to the at least one processor and the at least one memory. The method includes identifying, using the data management system, a project category for a real estate project based on preliminary project data provided by a project sponsor associated with the real estate project, and selecting, using the data management system, a project profile template from a plurality of project profile templates stored in the at least one memory based on the identified project category, where each project profile template associated with one of a plurality of project categories. The method further includes transmitting, using the data management system, a set of category-specific prompts to the project sponsor based on the identified project category, wherein the set is one of a plurality of sets of category-specific prompts stored in the at least one memory, and each set is associated with one of the project categories. The method further includes receiving, at the data management system, category-specific project data from the project sponsor, generating, using the data management system, a project profile for the real estate project by populating the selected project profile template with the category-specific project data using the at least one processor, and displaying, using the user access system, the project profile to a potential investor.

In yet another aspect, at least one non-transitory computer-readable storage media having computer-executable instructions embodied thereon is provided. When executed by at least one processor communicatively coupled to a data management system and a user access system, the computer-executable instructions cause the data management system to identify a project category for a real estate project based on preliminary project data provided by a project sponsor associated with the real estate project, and select a project profile template from a plurality of project profile templates based on the identified project category, where each project profile template is associated with one of a plurality of project categories. The computer-executable instructions further cause the data management system to transmit a set of category-specific prompts to the project sponsor based on the identified project category, wherein the set is one of a plurality of sets of category-specific prompts, and each set is associated with one of the project categories. The computer-executable instructions further cause the data management system to receive category-specific project data from the project sponsor, and generate a project profile for the real estate project by populating the selected project profile template with the category-specific project data using the at least one processor. When executed by the at least one processor, the computer executable instructions also cause the user access system to display the project profile to a potential investor.

### BRIEF DESCRIPTION OF THE DRAWINGS

FIGS. 1-8 show example embodiments of the methods and systems described herein.

FIG. 1 is a simplified block diagram of an example real estate project financing system.

FIG. 2 is an expanded block diagram of an example embodiment of a server architecture of the real estate project financing system shown in FIG. 1.

FIG. 3 illustrates an example configuration of a user system shown in FIGS. 1 and 2.

FIG. 4 illustrates an example configuration of a server system shown in FIGS. 1 and 2.

FIG. 5 is an example of an online real estate project financing environment in which project sponsors solicit financing for real estate projects from potential investors using the system shown in FIG. 1.

FIG. 6 is a flowchart of an example method of soliciting financing for real estate projects in the online real estate project financing environment shown in FIG. 5.

FIG. 7 is a flowchart of an example method for providing liquidity to shareholders of a real estate project in the online real estate project financing environment shown in FIG. 5.

FIG. 8 is an example configuration of a database within a computing device, along with other related computing components, that may be used to carry out the methods shown in FIGS. 6 and 7.

Although specific features of various embodiments may be shown in some drawings and not in others, this is for convenience only. Any feature of any drawing may be referenced and/or claimed in combination with any feature of any other drawing.

### DETAILED DESCRIPTION OF THE DISCLOSURE

The following detailed description of the embodiments of the disclosure refers to the accompanying drawings. The same reference numbers in different drawings may identify the same or similar elements.

Systems and methods are described herein for soliciting financing of real estate projects in an online environment in which project sponsors solicit financing for real estate projects from potential investors. In the example embodiments described herein, a real estate project financing system (REPF system) is provided that allows project sponsors to list real estate projects on the REPF system, and potential investors to view and invest in the real estate projects listed on the REPF system. In one embodiment, real estate projects are investment vehicles through which investors can passively invest in investment properties, such as commercial real estate (e.g., a retail shopping center), without taking on responsibilities or duties associated with owning and managing such investment properties. Real estate projects may be structured in a variety of manners. For example, a real estate project may be structured as a business entity, (e.g., a limited liability company) that investors receive shares or units of in return for their investment in the real estate project. Investors in the real estate project may receive a portion of the profits or revenue earned by the business entity and/or other income based on the number of shares or units of the business entity they own.

A project sponsor may be an individual or business entity, such as a property management company or a property development company, seeking to raise capital to purchase, acquire, improve, or otherwise invest in an investment property. In one embodiment, a project sponsor desiring to list a real estate project on the REPF system transmits preliminary project data to the REPF system associated with the real estate project. The preliminary project data includes basic information about the real estate project, such as the project sponsor's name, a target financing amount for the real estate project, a geographic location of the underlying investment property, and an intended use of the investment property.

The REPF system may use the preliminary project data to identify and assign a project category to the real estate project, such as a “retail” category or an “industrial” category. The REPF system may use the identified project category to collect information about the real estate project relevant to the specific project category, also referred to as category-specific project data, and create a project profile for the real estate project using the category-specific project data. The project profile includes information about the real estate project, such as the physical and/or financial characteristics of an investment property associated with the real estate project, that potential investors may use to analyze and assess the potential risks and rewards of investing in the real estate project.

In one embodiment, the REPF system collects category-specific project data by transmitting category-specific prompts (e.g., questions) to the project sponsor based on the project category assigned to the real estate project. The category-specific prompts are designed to elicit information relevant to the particular project category assigned to the real estate project. For example, category-specific prompts for a retail project category may include questions related to tenant exclusivity commitments, percentage rent rates, permitted retail uses, percentage of units occupied by high-volume businesses (e.g., restaurants), population or population density within a specified area (e.g., a 5 mile radius), and operating hours of a retail district or individual tenant businesses, whereas category-specific prompts for an industrial project category may include questions related to the availability of utility and power services, rail accessibility, the number and size of loading docks, ceiling heights, and permitted zoning uses.

The project sponsor provides category-specific project data in response to the category-specific prompts. Category-specific project data generally includes information related to the physical and financial characteristics of an underlying investment property associated with the real estate project. For example, category-specific project data may include a lot size, a building size, a number of units, historical financial information, projected financial information, and pro forma financial statements.

In some embodiments, the REPF system may also prompt the project sponsor to provide information related to the structure of the real estate project, also referred to as project structure information. Project structure information may include, for example, a target financing amount for the real estate project, an entity type of a business entity that will own and/or manage an investment property associated with the real estate project, a number of shares or units of the real estate project available for purchase, a price per share or unit, a duration of the real estate project, management fees, how proceeds from a sale of the investment property will be distributed, and liquidity options for investors of the real estate project.

The REPF system may generate a project profile for the real estate project using category-specific project data, preliminary project data, and/or project structure information. In some embodiments, the REPF system creates a project profile for the real estate project using a project profile template associated with the project category in which the real estate project is assigned. In some embodiments, project profile templates include information fields that are populated with, among other things, category specific project data to create project profiles. The information fields of each project profile template are relevant to the particular project category with which the project profile template is associated. For example, the REPF system may include a retail project profile template that includes information fields relevant to retail real estate projects, such as tenant exclusivity commitments, percentage of units occupied by high-volume businesses (e.g., restaurants), and population or population density within a specified area (e.g., a 5 mile radius). The REPF system may use the retail project profile template to create project profiles for each real estate project within the retail category. The REPF system may include a project profile template for each project category, and may use the same project profile template to generate project profiles for real estate projects within the same project category.

Potential investors may access the REPF system to view project profiles for various real estate projects. Potential investors may browse and compare project profiles for different real estate projects to determine which real estate projects to invest in. By using the same project profile template to create project profiles for real estate projects within the same project category, the REPF system facilitates comparison of real estate projects within the same category as compared to known systems.

In some embodiments, the potential investors that can access and/or invest in real estate projects listed on the REPF system may be limited to accredited investors. In other embodiments, potential investors may include both accredited investors and unaccredited investors (e.g., the general public or the “crowd”). Thus, in some embodiments, a system is provided that allows financing of real estate projects by a process sometimes referred to as “crowdfunding”.

In some embodiments, the REPF system is also configured to track the performance of successfully financed real estate projects, and generate updated project profiles for such real estate projects using project performance data provided by project sponsors. Project performance data includes operational and financial information related to the performance of a real estate project, and may include historical data, as well as projected operational and financial information based on the historical data. Project performance data may be collected by the REPF system by transmitting category specific prompts to a project sponsor.

The REPF system may generate an updated project profile for a real estate project using a project profile template associated with the project category in which the real estate project is assigned. For example, the REPF system may populate a project profile template with the project performance data to generate the updated project profile. Current investors of a real estate project may view an updated project profile associated with the real estate project in order to track the performance of their investment. Additionally, in some embodiments, updated project profiles may be viewed by potential investors such that potential investors may browse and review operating (e.g., previously financed) real estate projects, and invest in an operating real estate project during a subsequent round of financing for the real estate project. Because the updated project profiles are generated in the same manner as project profiles of unfinanced real estate projects, the REPF system facilitates comparison between operating real estate projects and unfinanced (or non-operational) real estate projects.

Also described herein are systems and methods for providing liquidity to shareholders of a real estate project using a REPF system, such as current investors of a successfully financed real estate project. As noted above, one drawback of investing in real estate for some investors is the difficulty for non-controlling shareholders to liquidate their interest in the real estate project. To make investing in a real estate project more attractive to potential investors, a project sponsor may offer liquidity options to non-controlling shareholders of the real estate project. The liquidity options may include, for example, cash dividends or an opportunity for shareholders to sell their shares at specified dates, time periods, and/or intervals. Liquidity options may be mandatory (i.e., the project sponsor may be obligated to pay shareholders exercising their liquidity options) or discretionary (i.e., the project sponsor has discretion to provide liquidity to shareholders). In one embodiment, for example, a project sponsor may, but is not obligated to, provide liquidity to shareholders in response to one or more shareholders indicating their desire to liquidate at least a portion of their interest in the real estate project.

In one embodiment, a project sponsor of a real estate project initiates a share offering for a previously financed real estate project to raise capital (e.g., cash) in order to pay shareholders who exercise their liquidity options. The project sponsor may initiate the share offering using the REPF system, for example, by sending a request to the REPF system to initiate the share offering. The request to initiate the share offering may include, for example, a number of shares of the real estate project to be offered for sale and a price per share.

Potential investors may view share offerings for real estate projects listed on the REPF system in substantially the same manner that potential investors may view project profiles for real estate projects listed on the REPF system. Potential investors that wish to invest in a real estate project through a share offering may transmit an investment request to the REPF system that includes, for example, a number of shares to be purchased by the potential investor.

The REPF system may determine the amount of funds raised from a share offering, also referred to as a proceeds amount, based on the investment requests received for a given share offering. For example, the REPF system may determine the proceeds amount for a share offering by multiplying the number of shares sold during the share offering by the respective price per share.

The REPF system may also determine an amount of money owed to a shareholder who exercises a liquidity option, also referred to as a compensation amount. The manner in which the REPF system determines the compensation amount for a shareholder may depend upon the type of liquidity option being exercised. In some embodiments, for example, the REPF system determines a compensation amount by determining a dividend amount for each outstanding share of the real estate project, and multiplying the dividend amount by the number of shares owned by the shareholder. In some embodiments, the REPF system may determine the dividend amount based on the proceeds amount and/or the value of an investment property associated with the real estate project (e.g., an appreciation value of the investment property). In another embodiment, a shareholder may sell shares of the real estate project in connection with the share offering, and the REPF system may determine a compensation amount for the shareholder based on the number of the shareholder's shares sold as a result of the share offering.

Described herein are computer systems such as a server system, a data management system, a user access system, project sponsor computing devices, potential investor computing devices, investor computing devices, and third-party professional computing devices. As described herein, all such computer systems include a processor and a memory. However, any processor in a computer device referred to herein may also refer to one or more processors wherein the processor may be in one computing device or a plurality of computing devices acting in parallel. Additionally, any memory in a computer device referred to herein may also refer to one or more memories wherein the memories may be in one computing device or a plurality of computing devices acting in parallel.

A technical effect of the systems and methods described herein includes at least one of: (a) identifying a project category for a real estate project based on preliminary project data provided by a project sponsor associated with the real estate project; (b) selecting a project profile template from a plurality of project profile templates stored in the memory based on the identified project category; (c) transmitting a set of category-specific prompts to the project sponsor based on the identified project category; (d) receiving category-specific project data from the project sponsor; (e) generating a project profile for the real estate project by populating the selected project profile template with the category-specific project data using a processor; (f) displaying the project profile to a potential investor; (g) receiving a request from a project sponsor associated with a real estate project to initiate a share offering; (h) transmitting the share offering to a potential investor; (i) receiving an investment request from the potential investor; (j) determining a proceeds amount for the share offering based on the investment request; and (k) determining, using a processor, a compensation amount owed to a shareholder of the real estate project based on at least one of the proceeds amount, a number of shares of the real estate project owned by the shareholder, and a number of shares of the real estate project sold by the shareholder as a result of the share offering.

As used herein, a processor may include any programmable system including systems using micro-controllers, reduced instruction set circuits (RISC), application specific integrated circuits (ASICs), logic circuits, and any other circuit or processor capable of executing the functions described herein. The above examples are exemplary only, and are thus not intended to limit in any way the definition and/or meaning of the term “processor.”

As used herein, the term “database” may refer to either a body of data, a relational database management system (RDBMS), or to both. As used herein, a database may include any collection of data including hierarchical databases, relational databases, flat file databases, object-relational databases, object oriented databases, and any other structured collection of records or data that is stored in a computer system. The above examples are exemplary only, and thus are not intended to limit in any way the definition and/or meaning of the term database. Examples of RDBMS's include, but are not limited to including, Oracle® Database, MySQL, IBM® DB2, Microsoft® SQL Server, Sybase®, and PostgreSQL. However, any suitable database may be used with the systems and methods described herein that enables the systems and methods to function as described herein. (Oracle is a registered trademark of Oracle Corporation, Redwood Shores, Calif.; IBM is a registered trademark of International Business Machines Corporation, Armonk, N.Y.; Microsoft is a registered trademark of Microsoft Corporation, Redmond, Wash.; and Sybase is a registered trademark of Sybase, Dublin, Calif.).

In one embodiment, a computer program is provided, and the program is embodied on a computer readable medium. In a further embodiment, the system is being run in a Windows® environment (Windows is a registered trademark of Microsoft Corporation, Redmond, Wash.). In yet another embodiment, the system is run on a mainframe environment and a UNIX® server environment (UNIX is a registered trademark of X/Open Company Limited located in Reading, Berkshire, United Kingdom). The application is flexible and designed to run in various different environments without compromising any major functionality. In some embodiments, the system includes multiple components distributed among a plurality of computing devices. One or more components may be in the form of computer-executable instructions embodied in a non-transitory computer-readable medium.

As used herein, an element or step recited in the singular and proceeded with the word “a” or “an” should be understood as not excluding plural elements or steps, unless such exclusion is explicitly recited. Furthermore, references to “example embodiment,” “illustrated embodiment,” or “one embodiment” of the present disclosure are not intended to be interpreted as excluding the existence of additional embodiments that also incorporate the recited features.

As used herein, the terms “software” and “firmware” are interchangeable, and include any computer program stored in memory for execution by a processor, including RAM memory, ROM memory, EPROM memory, EEPROM memory, and non-volatile RAM (NVRAM) memory. The above memory types are example only, and are thus not limiting as to the types of memory usable for storage of a computer program.

The systems and processes are not limited to the specific embodiments described herein. In addition, components of each system and each process can be practiced independent and separate from other components and processes described herein. Each component and process also can be used in combination with other assembly packages and processes.

The following detailed description illustrates embodiments of the disclosure by way of example and not by way of limitation.

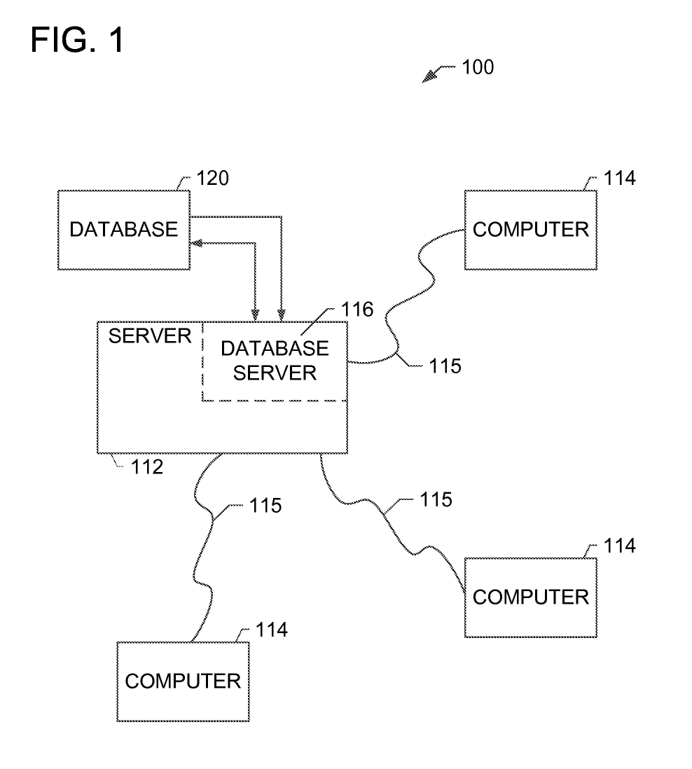

FIG. 1 is a simplified block diagram of an example real estate project financing (REPF) system 100. In the example embodiment, system 100 includes a server system 112 and a plurality of client subsystems, also referred to as client systems 114 or client computing devices, connected to server system 112. In one embodiment, client systems 114 are computers including a web browser, such that server system 112 is accessible to client systems 114 using the Internet. Client systems 114 are interconnected to the Internet through many interfaces including a network 115. Network 115 may be any suitable communication means that enables system 100 to function as described herein including, for example, a local area network (LAN) or a wide area network (WAN), dial-in-connections, cable modems, special high-speed Integrated Services Digital Network (ISDN) lines, and RDT networks. Client systems 114 may be any suitable device capable of interconnecting to the Internet including a personal computer, a laptop, a notebook, a hand held computer, a cellular telephone, a web-based phone, a personal digital assistant (PDA), or any other web-based connectable equipment that enables the system 100 to function as described herein.

A database server 116 is connected to a database 120 containing information on a variety of matters, as described below in greater detail. In one embodiment, database 120 is stored on server system 112 and may be accessed by potential users at one of client systems 114 by logging onto server system 112 through one of client systems 114. In any alternative embodiment, database 120 is stored remotely from server system 112 and may be non-centralized. Server system 112 could be any type of computing device configured to perform the steps described herein. Database 120 may include a single database having separated sections or partitions, or may include multiple databases, each being separate from each other.

As described below in greater detail, REPF system 100 facilitates financing real estate investment projects (“real estate projects”) sponsored by one or more project sponsors by soliciting financing for such real estate projects from potential investors. REPF system 100 receives project data from project sponsors, processes the project data, generates a category-specific project profile for the real estate project, and displays the project data to potential investors as a project profile that facilitates comparison of real estate projects within a given project category (e.g., industrial, retail, or office).

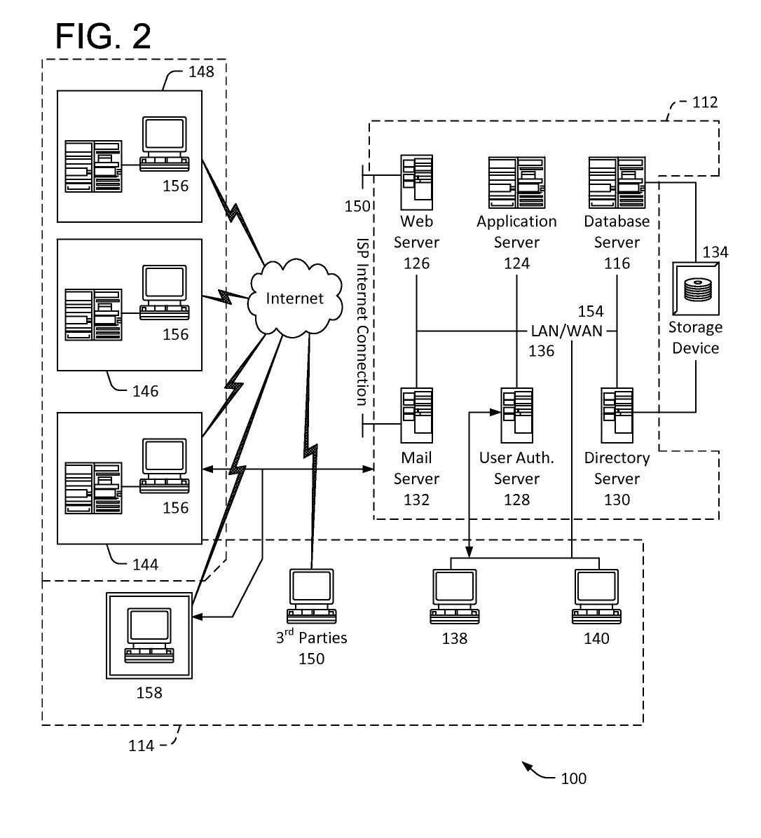

FIG. 2 is an expanded block diagram of an example embodiment of a server architecture of REPF system 100 including other computer devices in accordance with one embodiment of the present disclosure. Components in REPF system 100 identical to components of system 100 shown in FIG. 1 are identified in FIG. 2 using the same reference numerals as used in FIG. 1. As shown in FIG. 2, server system 112 includes database server 116, an application server 124, a web server 126, a user authorization server 128, a directory server 130, and a mail server 132. A storage device 134, such as database 120, is coupled to database server 116 and directory server 130. Servers 116, 124, 126, 128, 130, and 132 are coupled in a local area network (LAN) 136. In addition, a system host workstation 138 and a user workstation 140 are coupled to LAN 136. Alternatively, workstations 138 and 140 are coupled to LAN 136 using an Internet link or are connected through an Intranet.

Each workstation 138 and 140 is a personal computer having a web browser. Although the functions performed at the workstations typically are illustrated as being performed at respective workstations 138 and 140, such functions can be performed at one of many personal computers coupled to LAN 136. Workstations 138 and 140 are illustrated as being associated with separate functions only to facilitate an understanding of the different types of functions that can be performed by individuals having access to LAN 136.

Server system 112 is configured to be communicatively coupled to various entities, including project sponsors 144, potential investors 146, and investors 148, and to third parties, e.g., attorneys, accountants, or other professionals, 150 using an Internet connection 152. The communication in the example embodiment is illustrated as being performed using the Internet, however, any other wide area network (WAN) type communication can be utilized in other embodiments, i.e., the systems and processes are not limited to being practiced using the Internet. In addition, and rather than WAN 154, local area network 136 could be used in place of WAN 154.

In the example embodiment, any authorized individual or entity having a workstation 156 may access system 100. At least one of client systems 114 includes a manager workstation 158 located at a remote location. Workstations 156 and 158 include personal computers having a web browser. Also, workstations 156 and 158 are configured to communicate with server system 112.

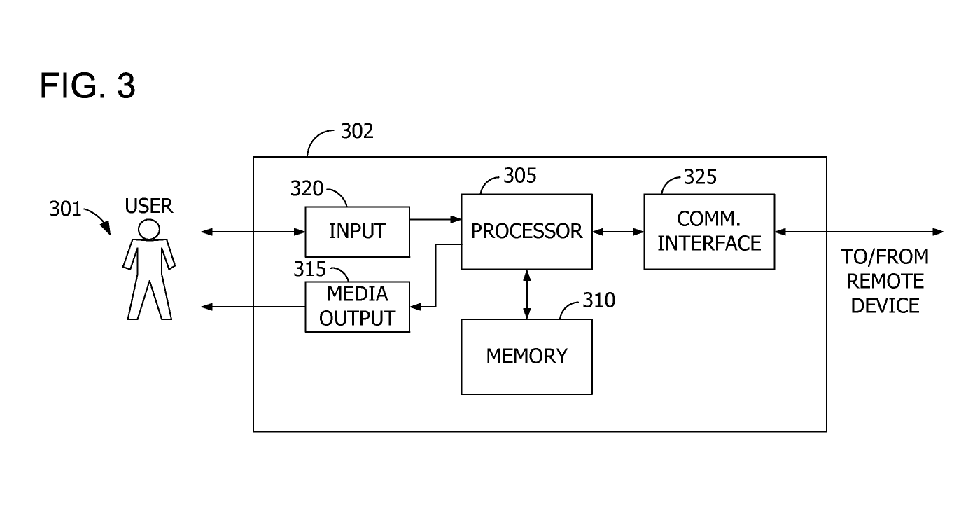

FIG. 3 illustrates an example configuration of a user system 302 operated by a user 301, such as project sponsor 144, potential investor 146, or investor 148 (shown in FIG. 2). User system 302 may include, but is not limited to, client systems 114, 138, and 140, workstation 156, and manager workstation 158. In the example embodiment, user system 302 includes a processor 305 for executing instructions. In some embodiments, executable instructions are stored in one or more memory devices 310. Processor 305 may include one or more processing units, for example, a multi-core configuration. Memory device 310 is any device allowing information such as executable instructions and/or written works to be stored and retrieved. Memory device 310 may include one or more computer readable media.

User system 302 also includes at least one media output component 315 for presenting information to user 301. Media output component 315 is any component capable of conveying information to user 301. In some embodiments, media output component 315 includes an output adapter such as a video adapter and/or an audio adapter. An output adapter is operatively coupled to processor 305 and operatively couplable to an output device such as a display device, a liquid crystal display (LCD), organic light emitting diode (OLED) display, or “electronic ink” display, or an audio output device, a speaker or headphones.

In some embodiments, user system 302 includes an input device 320 for receiving input from user 301. Input device 320 may include, for example, a keyboard, a pointing device, a mouse, a stylus, a touch sensitive panel, a touch pad, a touch screen, a gyroscope, an accelerometer, a position detector, or an audio input device. A single component such as a touch screen may function as both an output device of media output component 315 and input device 320. User system 302 may also include a communication interface 325, which is communicatively couplable to a remote device such as server system 112 and/or client systems 114 (shown in FIG. 2). Communication interface 325 may include, for example, a wired or wireless network adapter or a wireless data transceiver for use with a mobile phone network, Global System for Mobile communications (GSM), 3G, 4G, or other mobile data network or Worldwide Interoperability for Microwave Access (WIMAX).

Stored in one or more memory devices 310 are, for example, computer readable instructions for providing a user interface to user 301 via media output component 315 and, optionally, receiving and processing input from input device 320. A user interface may include, among other possibilities, a web browser and client application. Web browsers enable users, such as user 301, to display and interact with media and other information typically embedded on a web page or a website from server system 112. A client application allows user 301 to interact with a server application from server system 112.

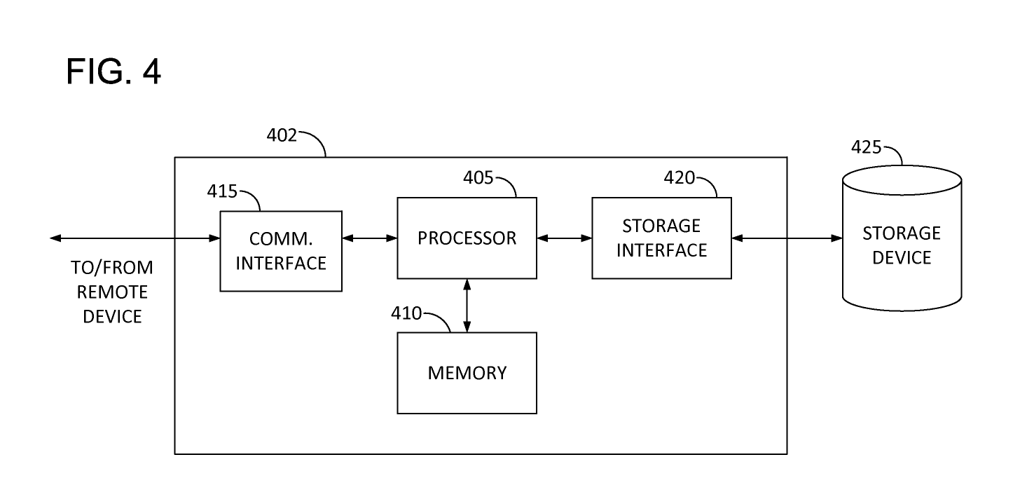

FIG. 4 illustrates an example configuration of a server computing device 402 such as server system 112 (shown in FIGS. 1 and 2). Server computing device 402 may include, but is not limited to, database server 116, application server 124, web server 126, user authorization server 128, directory server 130, and mail server 132.

Server computing device 402 includes a processor 405 for executing instructions. Instructions may be stored in one or more memory devices 410, for example. Processor 405 may include one or more processing units (e.g., in a multi-core configuration) for executing instructions. The instructions may be executed within a variety of different operating systems on the server computing device 402, such as UNIX, LINUX, Microsoft Windows®, or other suitable operating systems. It should also be appreciated that upon initiation of a computer-based method, various instructions may be executed during initialization. Some operations may be required in order to perform one or more processes described herein, while other operations may be more general and/or specific to a particular programming language (e.g., C, C#, C++, Java, or other suitable programming languages).

Processor 405 is operatively coupled to a communication interface 415 such that server computing device 402 is capable of communicating with a remote device such as a user system 302 or another server computing device 402. For example, communication interface 415 may send and receive information to and from client systems 114 via the Internet, as illustrated in FIG. 2.

Processor 405 may also be operatively coupled to a storage device 425. Storage device 425 is any computer-operated hardware suitable for storing and/or retrieving data. In some embodiments, storage device 425 is integrated in server computing device 402. For example, server computing device 402 may include one or more hard disk drives as storage device 425. In other embodiments, storage device 425 is external to server computing device 402 and may be accessed by a plurality of server computing devices 402. For example, storage device 425 may include multiple storage units such as hard disks or solid state disks in a redundant array of inexpensive disks (RAID) configuration. Storage device 425 may include a storage area network (SAN) and/or a network attached storage (NAS) system. Storage device 425 may include, but is not limited to, database 120 and storage device 134.

In some embodiments, processor 405 is operatively coupled to storage device 425 via a storage interface 420. Storage interface 420 is any component capable of providing processor 405 with access to storage device 425. Storage interface 420 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing processor 405 with access to storage device 425.

Memory device 410 may include, but are not limited to, random access memory (RAM) such as dynamic RAM (DRAM) or static RAM (SRAM), read-only memory (ROM), erasable programmable read-only memory (EPROM), electrically erasable programmable read-only memory (EEPROM), and non-volatile RAM (NVRAM). The above memory types are exemplary only, and are thus not limiting as to the types of memory usable for storage of a computer program.

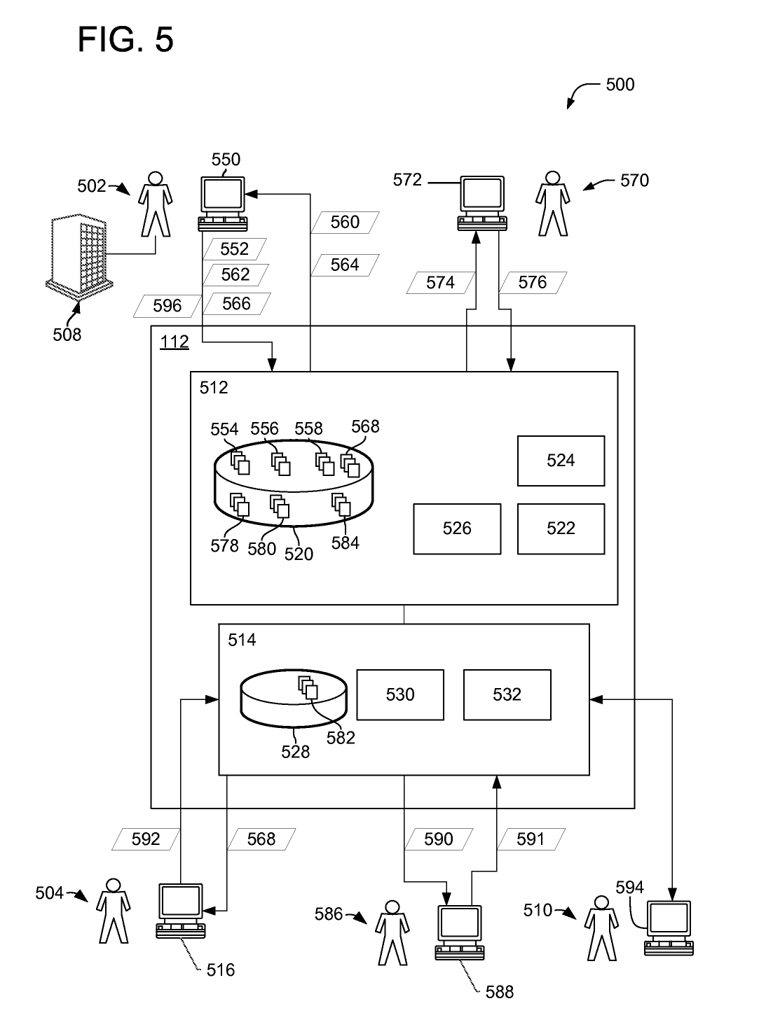

FIG. 5 is an example of an online real estate project financing environment 500 including server system 112 in which project sponsors 502 solicit financing for real estate projects from potential investors 504 using the system shown in FIG. 1. In one embodiment, real estate projects are investment vehicles through which potential investors can passively invest in investment properties (e.g., commercial real estate), such as investment property 508, without taking on responsibilities or duties associated with owning and managing such investment properties. In the illustrated embodiment, for example, a project sponsor 502 seeking to raise capital to purchase, acquire, improve, or otherwise invest in an investment property 508 uses server system 112 to solicit financing from potential investors 504 needed to carry out the transaction. Potential investors 504 desiring to invest in real estate may browse different real estate projects stored on server system 112, and invest in such real estate projects using server system 112. Server system 112 thereby facilitates financing real estate projects by providing project sponsors 502 with access to capital. Server system 112 further facilitates investing in real estate projects by providing a single, centralized location where potential investors 504 can browse, easily compare, and invest in different real estate projects. Further, as described in more detail herein, server system 112 facilitates providing liquidity to current investors 510 of real estate projects by allowing investors 510 to sell their shares of real estate projects to potential investors 504 and/or by allowing project sponsor 502 to pay out dividends to current investors 510.

Real estate projects can have many different suitable structures. In one embodiment, for example, a real estate project is a business entity (e.g., a limited liability company) formed for the purpose of owning and/or managing an investment property. The business entity may be managed by the project sponsor associated with the real estate project. Investors in the real estate project may receive an interest in the business entity (e.g., in the form of shares or units) proportional to their monetary investment in the real estate project, and may receive a portion of the profits earned by the business entity based on their interest in the business entity. In another suitable embodiment, a real estate project may be a debt-based project in which investors receive a fixed interest rate on their investment in the real estate project during the life of the project, and receive their principal investment back at the termination of the project.

In the example embodiment, server system 112 includes a data management system 512 and a user access system 514. Data management system 512 is configured to process project data received from project sponsors 502, and generate project profiles for each real estate project, as described in more detail herein. Data management system 512 is further configured to store secure data and documents, and provide access to such data and documents to only authorized users (e.g., a potential investor who executes a confidentiality agreement). User access system 514 is configured to store project profiles and/or copies of project profiles, and to serve project profiles to computing device 516 associated with potential investor 504. In the example embodiment, data management system 512 includes a data management database 520, an authorization component 522, a data management processing component 524, and a data management memory component 526. Further, in the example embodiment, user access system 514 includes a user access database 528, a user access processing component 530, and a user access memory component 532. In other embodiments, data management system 512 and user access system 514 may have any suitable configuration or architecture that enables systems 512 and 514 to function as described herein.

In the example embodiment, project sponsor 502 accesses server system 112 using a project sponsor computing device 550, and transmits preliminary project data 552 to server system 112. Project sponsor computing device 550 may include, for example, client system 114 or workstation 156 (shown in FIG. 2).

Preliminary project data 552 generally includes basic information about a real estate project that is used by server system 112 (or a user of server system 112) to identify and/or assign a project category to the real estate project. In some embodiments, preliminary project data 552 may also be used by server system 112 (or a user of server system 112) to determine whether a real estate project should be accepted onto server system 112. For example, server system 112 may be configured to reject real estate projects that do not meet certain investment property criteria specified by a system host. For example, server system 112 may be configured to reject real estate projects seeking to raise funds to purchase a single family residential home.

Preliminary project data 552 may include, for example, project sponsor identity information, a target financing amount for the project, a geographic location of the underlying investment property 508, an intended use of the investment property 508, and a property value of the investment property 508. Project sponsor 502 may transmit preliminary project data 552 to server system 112 via a web interface that allows project sponsor 502 to fill in information (e.g., sponsor name, address, etc.) or make a selection from a plurality of options (e.g., from a drop down menu). An example set of preliminary project data is shown below in Table 1:

TABLE 1
Preliminary Project Data

| Project Sponsor | Property | | Target financing |
|---|---|---|---|
| Identifier | Location | Intended Use | amount |
| Property | Chicago, | Retail | $4,000,000.00 |
| Development | Illinois | | |
| Co. | | | |

In the example of Table 1, project sponsor 502 is a business entity operating under the name “Property Development Co.” Investment property 508 is located in Chicago, Ill., and project sponsor 502 intends to use investment property 508 as a retail property. Project sponsor 502 is seeking to raise $4,000,000 for the real estate project.

Server system 112 receives and stores preliminary project data 552 at data management system 512. Server system 112 may create a project record 554 for the real estate project in which data associated with the real estate project is stored. In another suitable embodiment, server system 112 may update an already existing project record 554. Project record 554 may be stored in data management database 520. Further, server system 112 may create a project sponsor account 556 or update an already existing project sponsor account 556 stored on data management database 520.

Server system 112 assigns a project category from a plurality of project categories to the real estate project based on at least preliminary project data 552. Project categories are used by server system 112 to collect category-specific information on real estate projects, and to create consistent project profiles for real estate projects within the same project category, as described in more detail herein.

Project categories can include any suitable category that enables server system 112 to categorize real estate projects. Project categories can include, for example, categories based on industry, property type, and property size. In one suitable embodiment, for example, project categories include a retail category, an office category, an industrial category, a residential category, a single tenant category, a multi-tenant category, and a new development category. In some embodiments, a single real estate project may be assigned multiple project categories by server system 112. For example, server system 112 may assign a first project category and a second project category to each project, where the first project category is an industry-type category (e.g., retail, office, residential, industrial) and the second project category is a property-type category (e.g., single tenant, multi-tenant, new development). In one suitable embodiment, server system 112 is configured (i.e., programmed) to automatically assign a project category to a real estate project based on preliminary project data 552. In another suitable embodiment, server system 112 may receive input from another user, such as a system host operating, for example, system host workstation 138 (shown in FIG. 2), and assign a project category based on such user input.

An example project record including an assigned project category is shown below in Table 2:

TABLE 2
Project Record

| | | | Target | |
|---|---|---|---|---|
| Project | Project | Property | financing | Project |
| Identifier | Sponsor | Location | amount | Category |
| AAAA0001 | Property | Chicago, | $4,000,000.00 | Retail |
| | Development | Illinois | | |
| | Co. | | | |

In the example of Table 2, the real estate project is assigned to the retail project category based on the intended use provided by project sponsor 502. Also in the example of Table 2, the real estate project is assigned a unique project identifier such that server system 112 can identify, store, retrieve, and modify the project record associated with the real estate project.

Server system 112 includes a plurality of prompt sets 558 stored on data management system 512 (e.g., in data management database 520). Each prompt set 558 is associated with one of the project categories, and includes category-specific prompts designed to elicit information from the project sponsor that is relevant to the particular project category, also referred to herein as category-specific project data. For example, a prompt set associated with a retail project category may include questions related to tenant exclusivity commitments, percentage rent rates, permitted retail uses, percentage of units occupied by high-volume businesses (e.g., restaurants), population or population density within a specified area (e.g., a 5 mile radius), and operating hours of a retail district or individual tenant businesses. A prompt set associated with a residential project category may include questions related to a number of units, the number of bedrooms per unit, the number of bathrooms per unit, parking arrangements (e.g., covered parking, uncovered parking, street parking), tenant amenities, and the number of schools within a specified distance. A prompt set associated with an office project category may include questions related to a number of floors, the size of each floor, elevator accessibility, parking capacity, and lengths of tenant leases. A prompt set associated with an industrial project category may include questions related to the availability of utility and power services, rail accessibility, number and size of loading docks, ceiling heights, and permitted zoning uses.

Category-specific prompts may also include rules, requirements, directives, or other instructions regarding the manner in which category-specific data is to be provided by project sponsor 502. In one embodiment, for example, category-specific prompts may include instructions to project sponsor 502 to employ a certain methodology in assessing certain risk factors associated with the real estate project. In another embodiment, category-specific prompts may include a directive for project sponsor 502 to describe the methodology employed in assessing certain risk factors associated with the real estate project.

Server system 112 transmits a prompt set 560 to project sponsor 502 at project sponsor computing device 550 based on the project category in which the real estate project is assigned. In the example embodiment, server system 112 transmits a prompt set 560 associated with the retail project category to project sponsor computing device 550. The category-specific prompts included in the prompt set 560 may be displayed at project sponsor computing device 550 via a web interface. Project sponsor 502 provides category-specific project data 562 in response to the category-specific prompt using, for example, project sponsor computing device 550. Project sponsor 502 may input responses to category-specific prompt via a web interface that allows project sponsor 502 to fill in information in Tillable fields, or make a selection from a plurality of options (e.g., from a drop down menu).

Category-specific project data 562 generally includes information related to physical and financial characteristics of the underlying investment property 508 associated with a real estate project. Category-specific project data 562 may include, for example, a lot size, a building size, a number of units, historical financial information, projected financial information, pro forma financial statements, and any other information relevant to the category within which a real estate project is assigned. For example, category-specific project data for a real estate project assigned to a retail project category may include a percentage or number of units occupied by high-volume businesses (e.g., restaurants), a number and description of tenant exclusivity commitments, rent rate percentages, permitted retail uses, population or population density within a specified area (e.g., a 5 mile radius), and operating hours of a retail district or individual tenant businesses, whereas category-specific project data for a real estate project assigned to an office project category may include a number of floors, the size of each floor, a number of elevators servicing the floors, parking capacity, and the lengths of tenant leases.

Category-specific project data 562 is transmitted from project sponsor computing device 550, and received at data management system 512. Server system 112 may store category-specific project data 562 in a project record 554 associated with the real estate project. For example, server system 112 may retrieve the project record 554 associated with the real estate project, and update the project record with category-specific project data 562 received from project sponsor 502.

Server system 112 also transmits a prompt 564 to project sponsor 502 at project sponsor computing device 550 to provide information related to the structure of the real estate project, also referred to herein as project structure information. Project structure information may include, for example, whether the real estate project is an equity-based project or a debt-based project, a target financing amount for the real estate project, an entity type of a business entity that will own and/or manage the investment property 508 (e.g., a limited liability company or a limited liability partnership), a number of shares or units of the entity available for purchase by potential investors, a price per share or unit, a duration of the real estate project, management fees, how profits will be distributed, how proceeds from a sale of the investment property 508 will be distributed, and liquidity options for investors 510. Project sponsor 502 provides project structure information 566 in response to the prompt from server system 112 using, for example, project sponsor computing device 550. Project sponsor 502 may input project structure information 566 via a web interface that allows project sponsor 502 to fill in information in Tillable fields, or make a selection from a plurality of options (e.g., from a drop down menu).

In some suitable embodiments, prompt 564 may include one or more suggested or defined project structures, and server system 112 may prompt project sponsor 502 to select a project structure from the suggested or defined project structures. The suggested or defined project structures may be based, for example, on category-specific project data 562 and/or project structures used in similar real estate projects (e.g., real estate projects within the same category) that were successfully financed. In other suitable embodiments, prompt 564 may include project structure options, and server system 112 may prompt project sponsor 502 to make selections of the project structure options provided by server system 112. Project structure options may be based, for example, on category-specific project data 562 and/or project structures used in similar real estate projects that were successfully financed. For example, server system 112 may prompt project sponsor 502 to select one of a limited liability company and a limited liability partnership as the entity type for the business entity that will own and/or manage the investment property 508.

Project structure information 566 is transmitted from project sponsor computing device 550, and received at data management system 512. Server system 112 may store project structure information 566 in a project record 554 associated with the real estate project. For example, server system 112 may retrieve the project record 554 associated with the real estate project, and update the project record with project structure information 566 received from project sponsor 502.

In one embodiment, server system 112 is configured to generate investment documents 568 related to the real estate project, such as a private placement memorandum, an offering memorandum, a subscription agreement, a confidentiality agreement, and other investor disclosure documents based on at least project structure information 566. Server system 112 may generate investment documents 568 automatically using data management processing component 524. In other suitable embodiments, server system 112 may generate investment documents 568 with the assistance of human input, such as third-party professionals 570 (e.g., attorneys and accountants) operating a third-party computing device 572. For example, server system 112 may generate draft investment documents 574 based on preliminary project data 552, category-specific project data 562, and/or project structure information 566, and transmit or make available draft investment documents 574 to third-party computing device 572 for review, editing, and/or approval by third-party professional 570. Third-party professional 570 may review and edit draft investment documents 574 using third-party computing device 572, and transmit approved investment documents 576 to server system 112. Alternatively, third-party professional 570 may transmit an approval message to server system 112 indicating that draft investment documents 574 have been reviewed and approved by third-party professional 570.

Server system 112 may transmit or make available approved investment documents 576 to project sponsor 502 for additional review, editing, and/or approval. Project sponsor 502 may review and edit approved investment documents 576 using project sponsor computing device 550, and transmit modified investment documents to server system 112. Alternatively, project sponsor 502 may transmit an approval message to server system 112 indicating that draft investment documents 574 and/or approved investment documents 576 have been reviewed and approved by project sponsor 502.

Server system 112 may store investment documents 568, including draft investment documents 574 and approved investment documents 576, on data management system 512. Further, server system 112 may transmit or make available investment documents 568 to potential investors 504 for review and electronic signature, as described in more detail herein.

Server system 112 is configured to generate a project profile 578 for each real estate project by populating one of a plurality of project profile templates 580 with category-specific project data 562. Project profiles 578 are made available to potential investors 504 through user access system 514 such that potential investors 504 can view or otherwise perceive information related to real estate projects being financed using server system 112. As described in more detail herein, project profiles 578 for real estate projects within the same project category are generated using the same project profile template such that project profiles 578 for real estate projects within the same project category include the same type of information. Server system 112 thereby facilitates comparison of different real estate projects within a given project category.

In the illustrated embodiment, project profile templates 580 are stored on data management system 512 (e.g., in data management database 520). Each project profile template 580 is associated with one of the project categories, and includes a plurality of information fields (e.g., a database structure or a database schema) that may be populated with information based on category-specific project data 562 to generate a project profile 578. The information fields of project profile templates 580 may vary based on the project category with which the project profile template is associated. For example, a project profile template associated with a retail project category may include information fields for a number of tenant exclusivity commitments associated with an investment property, a description of tenant exclusivity commitments, percentage rent rates for current and/or anticipated tenant leases, permitted retail uses, a percentage or number of units occupied by high-volume businesses (e.g., restaurants), a population or population density within a specified area (e.g., a 5 mile radius), and operating hours of a retail district or individual tenant businesses associated with an investment property. A project profile template associated with a residential project category may include information fields for a number of units associated with an investment property, the number of bedrooms per unit, the number of bathrooms per unit, parking arrangements (e.g., covered parking, uncovered parking, street parking), tenant amenities, and the number of schools within a specified distance of an investment property. A project profile template associated with an office project category may include information fields for a number of floors associated with an investment property, a size of each floor, a number of elevators servicing the floors, a parking capacity associated with the investment property, and the lengths of current and/or anticipated tenant leases.

An example project profile template associated with a retail project category is shown below in Table 3:

TABLE 3
Project Profile Template

| | |
|---|---|
| Project Sponsor: | |
| Property Location: | |
| Property Type: | Retail |
| Target financing amount: | |
| Project Type: | |
| Number of Tenant Units: | |
| Current Tenants: | |
| Occupancy Percentage: | |
| Parking Capacity: | |
| Percentage of High-Volume Tenants: | |
| Population within 5 mile radius: | |
| Hours of Operation: | |

The example project profile template includes information fields for a project sponsor's name, a geographic location of an investment property, a project category (i.e., “Property Type”), a target financing amount for a real estate project, a project type for a real estate category (e.g., equity-based or debt-based), the total number of tenant units at the investment property, tenants of the investment property that are currently under a lease agreement or other tenant agreement, the occupancy percentage of the investment property, the parking capacity of the investment property, the percentage of high-volume tenants (e.g., a restaurant) at the investment property, the population within a 5 mile radius of the investment property, and the hours of operation of the investment property (e.g., the hours during which at least one tenant of the investment property is open for business). In the example of Table 3, the information fields are not populated except for the “Property Type” information field, which is pre-populated with “Retail” to indicate that the project profile template is associated with a retail project category.

Server system 112 generates a project profile 578 for a real estate project by populating a project profile template 580 with information from category-specific project data 562 received from project sponsor 502. More specifically, server system 112 generates a project profile 578 for a real estate project by retrieving a project profile template 580 associated with the project category assigned to the real estate project (e.g., retail), creating project profile 578 using the data structure described by template 580, and populating project profile template 580 with information from category-specific project data 562 provided by project sponsor 502. In some embodiments, project profile template 580 is created based on a master project profile template associated with a project category (e.g., by cloning the master project profile template). An example project profile generated using the example project profile template of Table 3 is shown below in Table 4:

TABLE 4
Project Profile

| | |
|---|---|
| Project Sponsor: | Property Development Co. |
| Property Location: | Chicago, Illinois |
| Property Type: | Retail |
| Target financing amount: | $4,000,000.00 |
| Project Type: | Equity purchase |
| Number of Tenant Units | 5 |
| Current Tenants: | ABC Diner |
| | City Grocer |
| | Corner Coffee |
| | Smith & Jones Ltd. |
| Occupancy Percentage | 80% |
| Parking Capacity: | 200 vehicles |
| Percentage of High-Volume | 40% |
| Tenants: | |
| Population within 5 mile | 50,000 |
| radius: | |
| Hours of Operation: | Monday-Thursday.: 7 am-9 pm |
| | Friday-Saturday: 7 am-11 pm |
| | Sunday: 8 am-8 pm |

In one suitable embodiment, the information fields of project profile template 580 are populated directly with category-specific project data 562. For example, in the example of Table 4, the information fields for “Number of Tenant Units,” “Current Tenants,” “Parking Capacity,” and “Population within 5 mile radius” may be populated directly with category-specific project data 562 provided by project sponsor 502. In another suitable embodiment, the information fields of project profile template 580 are populated by processing one or more portions of category-specific project data 562, and populating the information fields of project profile template 580 with the processed data. For example, in the example of Table 4, server system 112 divides a total number of current tenants by the number of tenant units to determine the occupancy percentage of 80%, and populates the information field for “Occupancy Percentage” with “80%”. In yet other suitable embodiments, server system 112 may generate project profile 578 by populating project profile template 580 with information based on preliminary project data 552 and/or project structure information 566. For example, in the example of Table 4, project profile 578 is generated by populating the “Project Sponsor” and “Property Location” information fields of project profile template 580 with preliminary project data 552, and by populating the “Project Type” field with project structure information 566.

Server system 112 is configured to serve project profiles 578 to potential investors 504. More specifically, server system 112 is configured to display or cause to be displayed at potential investor computing device 516 a project profile 578 in response to receiving a request from potential investor computing device 516 to view or access the project profile 578. For example, server system 112 may present profiles 578 to investors 504 through a web server over the Internet.

In one suitable embodiment, server system 112 stores project profiles 578 on data management system 512, and may store a copy 582 of each project profile 578 on user access system 514. Potential investor 504 may access project profile 578 by logging on to server system 112 using user access system 514, and accessing copy 582 of project profile 578 stored on user access system 514.

In another suitable embodiment, server system 112 generates project profile 578 in response to receiving a request to view a project profile from potential investor computing device 516. For example, server system 112 receives a request from potential investor computing device 516 to view a project profile associated with a real estate project at user access system 514. User access system 514 transmits the request to data management system 512, and data management system 512 generates project profile 578 by populating a project profile template 580 as described above. Data management system 512 transmits project profile 578 to user access system 514, and user access system 514 serves project profile 578 to potential investor computing device 516. Project profile 578 may be served by server system 112 by transmitting project profile 578 to potential investor computing device 516 or displaying project profile 578 at potential investor computing device 516 via a web interface.

In some embodiments, server system 112 may require verification that potential investor 504 satisfies certain criteria before server system 112 will provide potential investor 504 access to project profiles 578. For example, server system 112 may require that a potential investor be an Accredited Investor as defined by Rule 501 of Regulation D of U.S. federal securities law (hereinafter, “Accredited Investor”). Accordingly, in some embodiments, server system 112 transmits a prompt to potential investor computing device 516 to provide investor credential information. Investor credential information may include, for example, a potential investor's name, a potential investor's social security number, a potential investor's individual net worth, a potential investor's joint net worth, a potential investor's employer, a potential investor's individual annual income for certain number of years (e.g., the two most recent years), and a potential investor's joint annual income for a certain number of years.

Server system 112 receives the investor credential information from potential investor computing device 516, and compares the investor credential information with investor credential criteria stored on server system 112. Investor credential criteria may be defined by a system host and/or a project sponsor 502, and may include, for example, certain capital or income requirements. For example, investor credential criteria may include the net worth and annual income requirements required for a natural person to be considered an Accredited Investor. If server system 112 determines that the investor credential information satisfies the investor credential criteria, server system 112 may update or modify an investor account 584 associated with the potential investor to indicate that the potential investor is verified.

When server system 112 receives a request to view or access a project profile 578 from potential investor 504, server system 112 may retrieve an investor account 584 associated with potential investor 504 and determine whether or not potential investor 504 is verified or unverified. The server system 112 may be configured to serve project profiles 578 to only verified potential investor computing devices operated by verified potential investors, such as potential investor 504.

Information used to generate project profiles 578, such as preliminary project data 552, category-specific project data 562, and project structure information 566, may include information that project sponsor 502 is obligated to and/or desires to keep confidential (i.e., confidential information). Accordingly, in some suitable embodiments, server system 112 may serve or display different project profiles for the same real estate project and/or different subsets of data from a single project profile depending upon whether a potential investor is verified to view confidential information associated with the real estate project.

In one embodiment, for example, server system 112 may store a redacted copy of project profile 578 on user access system 514 that has confidential information redacted, omitted, or hidden from potential investors that are not authorized to view confidential information for the real estate project, such as unauthorized potential investor 586 operating computing device 588. The redacted copy of project profile 578 may be accessible to any potential investor, including, unauthorized potential investor 586. The unredacted copy of project profile 578 is stored on data management system 512, and is accessible by authorized potential investors, such as potential investor 504, but not unauthorized potential investors 586.

In another suitable embodiment, server system 112 generates project profile 578 based on a potential investor's status as “authorized” or “unauthorized”. For example, when server system 112 receives a request from a potential investor to view project profile 578, server system 112 retrieves an investor account 584 associated with the potential investor to determine whether the potential investor is authorized or unauthorized to view confidential information for the associated real estate project. If the server system 112 determines the potential investor is an unauthorized potential investor, such as unauthorized potential investor 586, server system 112 generates project profile 578 by populating a project profile template 580 with only non-confidential information. If server system 112 determines the potential investor is an authorized potential investor, such as potential investor 504, server system 112 generates project profile 578 by populating a project profile template 580 with confidential and non-confidential information. Server system 112 may serve the generated project profile 578 to potential investors 504, 586 in any suitable manner as described above.

In another suitable embodiment, server system 112 serves or displays different subsets of data, or “views”, from a single project profile depending upon whether the potential investor is an unauthorized potential investor 586 or an authorized potential investor 504. For example, server system 112 may serve or display a “limited” or first view of project profile 578 to unauthorized potential investor 586, and a “detailed” or second view of project profile 578 to authorized potential investor 504. The limited view may include, for example, only non-confidential information, and the detailed view may include, for example, non-confidential information and confidential information. Server system 112 may be configured to display other views of project profile 578, such as an unlimited view to project sponsor 502 including all information within project profile 578.

Server system 112 is configured to authorize potential investors to view confidential information using authorization component 522. In one embodiment, a potential investor receives authorization to view confidential information for a particular real estate project by executing a confidentiality agreement associated with the real estate project. For example, when server system 112 determines a potential investor is unauthorized to view confidential information for a particular real estate project, authorization component 522 may retrieve a confidentiality agreement 590 associated with the real estate project stored on data management database 520, and transmit confidentiality agreement 590 to unauthorized potential investor 586 with instructions to execute the agreement. Unauthorized potential investor 586 may digitally sign the confidentiality agreement using unauthorized potential investor computing device 588, and transmit the digitally signed confidentiality agreement 191 back to server system 112. When server system 112 receives the signed confidentiality agreement 191, authorization component 522 may retrieve and update or modify an investor account 584 associated with unauthorized potential investor 586 to indicate unauthorized potential investor 586 is now authorized to view confidential information for the real estate project.

In one embodiment, when server system 112 receives a request from a potential investor to view a project profile, server system 112 determines whether the potential investor is an authorized potential investor 504 or an unauthorized potential investor 586. For example, user access system 514 may transmit an authorization inquiry to data management system 512 in response to receiving a request from a potential investor to view project profile 578. The authorization inquiry may include, for example, a unique identifier associated with the potential investor and/or an investor account 584 associated with the potential investor. Data management system 512 may retrieve an investor account 584 associated with the potential investor to determine if the potential investor is an authorized potential investor 504 or an unauthorized potential investor 586, and transmit an authorization message to user access system 512 indicating whether the potential investor is an authorized potential investor 504 or an unauthorized potential investor 586. User access system 514 may then display one of the views of project profile 578 (e.g., the limited view or the detailed view) based on the authorization message.

A potential investor, such a potential investor 504, that desires to invest in a real estate project transmits an investment request 592 to server system 112 using potential investor computing device 516. Investment request 592 generally includes information related to potential investor's 504 desired investment. Investment request 592 may include, for example, a number of shares to be purchased by potential investor 504, a monetary value to be invested by potential investor 504, and a maximum price per share potential investor 504 is willing to pay (e.g., in the event the real estate project is over-subscribed or over-funded).

Server system 112 receives investment request 592 at user access system 514, and serves one or more investment documents 568 associated with the real estate project to potential investor 504 for review and/or signature by potential investor 504. In one suitable embodiment, for example, server system 112 serves a subscription agreement to potential investor 504 with instructions to execute the subscription agreement. The subscription agreement commits potential investor 504 to purchase a specified number of shares and/or to invest a specified monetary value if the associated real estate project is successfully financed. The subscription agreement may be populated by server system 112 with information based on investment request 592, such as the number of shares to be purchased or a monetary value to be invested by potential investor 504. Potential investor 504 may digitally sign the subscription agreement using potential investor computing device 516, and transmit the digitally signed subscription agreement back to server system 112.

In some embodiments, server system 112 may require verification that potential investor 504 satisfies certain criteria before server system 112 will serve investment documents 568 in response to investment request 592. For example, if server system 112 does not require verification of potential investor 504 prior to serving project profiles 578, server system 112 may require verification that potential investor 504 satisfies certain investor credential criteria before serving investment documents 568 to potential investor 504.

Server system 112 may modify or update a project record 554 and/or a project profile 578 associated with a real estate project to indicate the progress of financing the real estate project. For example, after server system 112 receives a signed subscription agreement from potential investor 504, server system may update the project record 554 and/or project profile 578 associated with the real estate project to indicate the total amount of funds committed by potential investors 504 for the real estate project.

A real estate project may be listed on server system 112 for a set period of time (i.e., a financing period) or until the real estate project is successfully financed. In other suitable embodiments, a real estate project may be listed on server system 112 indefinitely. When a real estate project is successfully financed, potential investors that committed to purchase shares or otherwise invest in the real estate project are obligated to transmit funds to the project sponsor of the real estate project in accordance with investment documents signed by the potential investors. A potential investor becomes an investor of a real estate project, such as investor 510, after transferring funds to the project sponsor of the real estate project in accordance with the investment documents associated with the real estate project. The project sponsor of the real estate project is similarly obligated to investors of the real estate project to fulfill duties and obligations in accordance with the investment documents associated with the real estate project. For example, the project sponsor may be obligated to issue shares of a business entity to the investors in accordance with a subscription agreement.

In some embodiments, server system 112 may be configured to transfer funds between potential investor 504 and project sponsor 502 of a successfully financed real estate project. In one embodiment, for example, when server system 112 receives a subscription agreement or similar investment document signed by potential investor 504, server system 112 transmits a prompt to the potential investor 504 to provide funding source identity information. Funding source identity information includes information related to a funding source that will be used to fund an investment in the real estate project. Funding source identity information may include, for example, account information for an account (e.g., a bank account) associated with potential investor 504. Server system 112 receives funding source identity information from potential investor 504, including a funding source account (e.g., a bank account) associated with potential investor 504. Server system 112 withdraws funds from the funding source account, and electronically deposits the funds in an escrow account. The funds are held in the escrow account, for example, until the real estate project is successfully financed or until a financing period associated with the real estate project has expired. In one embodiment, server system 112 determines whether a real estate project is successfully financed by determining if the target financing amount for the real estate project has been met within the financing period. If the real estate project is successfully financed, server system 112 transfers the funds from the escrow account into a project fund account associated with the real estate project and/or project sponsor 502. If the real estate project is not successfully financed (e.g., if the target financing amount is not met within the financing period), server system 112 returns the funds to the funding source account associated with potential investor 504.

In another suitable embodiment, server system 112 may be configured to communicate with an external financial institution associated with one or more of project sponsor 502, potential investor 504, and investor 510 to facilitate transferring funds between projector sponsor 502, potential investor 504, and/or investor 510.

In some embodiments, the total amount of funds committed by potential investors to fund a real estate project may exceed the target financing amount for the real estate project. Such real estate projects are referred to herein as over-funded or over-subscribed real estate projects. In one suitable embodiment, server system 112 is configured to fulfill investment requests 592 for over-subscribed real estate projects on a pro-rata basis. That is, server system 112 is configured to fulfill the same proportion of each investment request 592 based on the amount by which the real estate project is over-subscribed. For example, where a real estate project is over-subscribed by 11.1%, server system 112 fulfills approximately 90% of each investment request 592 such that the total funds to be paid by potential investors of the real estate project is equal to the target financing amount for the real estate project.

In another suitable embodiment, server system 112 may be configured to fulfill investment requests 592 for over-subscribed real estate projects based on the order in which the investment requests 592 are received. In one suitable embodiment, for example, server system 112 fulfills investment requests 592 received up until a point in time when the target financing amount for a real estate project is met, and does not fulfill investment requests 592 received after the target financing amount is met.

In another suitable embodiment, server system 112 is configured to fulfill investment requests 592 based on a maximum price per share specified by potential investors in each investment request 592. For example, each investment request 592 for a real estate project may include a maximum price per share that a potential investor is willing to pay in the event the real estate project is over-subscribed. Where the real estate project is over-subscribed, server system 112 may be configured to determine a premium price per share for the real estate project such that only investment requests having a maximum price per share greater than or equal to the premium price per share are fulfilled. Server system 112 may determine the premium price per share such that the total amount of funds to be paid by potential investors is substantially equal to the target financing amount. For example, the premium price per share may be determined such that the product of the premium price per share and the total number of shares requested in investment requests 592 having a maximum price per share greater than the premium price share is approximately equal to the target financing amount. Server system 112 may thus be configured to “re-price” shares or units of a real estate project based on the demand for shares of the real estate project.

Server system 112 is further configured to track the performance of successfully financed real estate projects such that investors, such as investor 510, may follow the performance of the real estate projects in which they have invested by accessing server system 112 using investor computing device 594. In one embodiment, for example, server system 112 receives project performance data 596 associated with a real estate project, and serves project performance data 596 to investors of the real estate project. Project performance data 596 may be provided, for example, from project sponsor 502 operating project sponsor computing device 550.

Project performance data 596 includes operational and financial information related to the performance of a real estate project. Project performance data 596 may include historical operational and financial data, and projected and/or revised operational and financial data based on the historical operational and financial data. Project performance data 596 may include, for example, revenue earned by the real estate project, expenses incurred by the real estate project, profits earned by the real estate project, current and past values of an investment property associated with the real estate project, and the current value or price of a share or unit of the real estate project. Project performance data 596 may also include, for example, updated or revised category-specific project data, such as the current tenants of an investment property associated with the real estate project.

Server system 112 may transmit a prompt to project sponsor computing device 550 associated with project sponsor 502 to request project performance data 596. In some embodiments, server system 112 may transmit a prompt set 558 to project sponsor 502 in a similar manner as described above to prompt project sponsor 502 to provide project performance data 596. Alternatively, project sponsor 502 may provide project performance data 596 without a prompt.

Server system 112 may store project performance data 596 on data management system 512, and serve project performance data 596 to investors of the real estate project, such as investor 510, through user access system 514.

In some embodiments, server system 112 may also be configured to generate an updated project profile for a real estate project based on project performance data 596. For example, server system 112 may generate an updated project profile by retrieving a project profile template 580 associated with the project category assigned to the real estate project (e.g., retail), and populating the project profile template 580 with project performance data 596. Generating an updated project profile may also include populating the project profile template 580 with category-specific project data 562.

Server system 112 may display updated project profiles to current investors 510 of a real estate project corresponding to the updated project profile such that current investors 510 may track the performance of their investments. Further, in some embodiments, updated project profiles may be viewed by potential investors 504 such that potential investors 504 may browse and review operating (e.g., previously financed) real estate projects, and invest in an operating real estate project during a subsequent round of financing for the real estate project, such as a share offering (described in more detail below). Because updated project profiles are generated in the same manner as project profiles of unfinanced real estate projects, server system 112 facilitates comparison between operating real estate projects and unfinanced (or non-operational) real estate projects.

Server system 112 may track real estate project performance and update project profiles as described above for real estate projects financed using server system 112. Additionally or alternatively, in at least some embodiments, server system 112 is configured to track real estate project performance and update project profiles for real estate projects financed outside of server system 112. In one embodiment, for example, project sponsors of real estate projects financed outside of server system 112 may utilize server system 112 to keep current investors of such real estate projects informed on the performance of their investments, and to attract potential investors to invest in such real estate projects (e.g., during a share offering, described below). In another embodiment, server system 112 is configured to receive and store real estate project data, such as project performance data, associated with real estate projects financed outside of server system 112 from investors. For example, an investor may upload project performance data, such as earnings reports, to server system 112 associated with a real estate project financed outside of server system 112. Server system 112 may be configured to store such project performance data, and display the project performance data to the investor, along with other project performance data for real estate projects in which the investor has invested either through server system 112 or outside of server system 112. In other words, server system 112 may provide investors with a centralized location to monitor and track their investments in real estate projects, including real estate projects financed outside of server system 112.

Server system 112 further provides investors 510 of real estate projects, particularly non-controlling shareholders of real estate projects, with increased liquidity as compared to known systems. In particular, server system 112 enables project sponsors (also referred to herein as controlling shareholders) to initiate share offerings after a real estate project is financed, and to pay dividends to and/or buy back shares of the real estate project from original investors (i.e., shareholders).

In one embodiment, for example, project sponsor 502 may initiate a share offering for a previously financed real estate project by sending a request to server system 112 using project sponsor computing device 550. The request may include, for example, a number of shares of the real estate project to be offered for sale in the share offering and a price per share for shares to be offered for sale in the share offering. The shares offered for sale during the share offering may correspond to existing shares of the real estate project (also referred to herein as “primary shares”) and/or the shares offered for sale may be newly issued shares of the real estate project (also referred to herein as “secondary shares”).

Project sponsor 502 may be obligated to initiate a share offering (e.g., based on duties and obligations specified in investment documents associated with the real estate project), or project sponsor 502 may have discretion to initiate a share offering. In some embodiments, project sponsor 502 may initiate a share offering based on information received from server system 112 related to investor “demand” for the real estate project. In one embodiment, for example, server system 112 is configured to receive a message from a potential investor, such as potential investor 504, indicating the potential investor's willingness to invest in the real estate project (e.g., after potential investor 504 views an updated project profile associated with the real estate project). The message may include, for example, an amount of money potential investor 504 is willing to invest in the real estate project, a price per share potential investor 504 is willing to pay for a share of the real estate project, and a number of shares of the real estate project that potential investor 504 is willing to purchase. Server system 112 may be configured to transmit the message from potential investor 504 to project sponsor 502 such that project sponsor 502 may gauge investor demand for the real estate project and determine when to initiate a share offering.

Additionally or alternatively, server system 112 may be configured to receive a message from a shareholder of the real estate project, such as current investor 510, indicating the shareholder's willingness to liquidate at least a portion of their shares of the real estate project. The message may include, for example, a monetary value of the shareholder's interest in the real estate project that the shareholder is willing to liquidate, a price per share that the shareholder is willing to sell shares of the real estate project for, and a number of shares of the real estate project that the shareholder is willing to sell. Server system 112 may be configured to transmit the message from the shareholder to project sponsor 502 such that project sponsor 502 may gauge shareholders' willingness to liquidate their interests in the real estate project and determine when to initiate a share offering.

Server system 112 receives the request to initiate a share offering, and transmits the share offering to potential investors, such as potential investor 504, in response to receiving a request from potential investor computing device 516 to view the share offering. Server system 112 may transmit the share offering, for example, by modifying an existing project profile 578 to include the details of the share offering, and serving the project profile 578 to potential investors through user access system 514. In some embodiments, server system 112 may transmit the share offering by generating an updated project profile using project performance data 596, modifying the updated project profile to include the details of the share offering, and displaying the updated project profile to potential investors. Additionally or alternatively, server system 112 may modify a project record 554 associated with the real estate project to include the details of the share offering and/or generate a project profile in a similar manner as described above including the details of the share offering.

A potential investor, such as potential investor 504, desiring to purchase shares in the real estate project through the share offering transmits an investment request, such as investment request 592, to server system 112. The investment request may include, for example, a number of shares to be purchased by potential investor 504 and a monetary value to be invested by potential investor 504. The investment request may also include a maximum price per share

In some embodiments, server system 112 may be configured to determine a price per share for shares offered for sale in the share offering. In one embodiment, for example, server system 112 determines a price per share for shares of the real estate project offered for sale in the share offering based on the maximum price per share from each investment request.

In another embodiment, server system 112 may determine a price per share for shares of the real estate project offered for sale in the share offering based on the appreciation of an investment property associated with the real estate project. For example, a project record 554 associated with the real estate project may include an entry associated with the appreciation of the investment property. The appreciation of the investment property may be determined by server system 112 based on the current value of the investment property and a previous value of the investment property. Server system 112 may determine a price per share based on the appreciation of the investment property such that the amount of money raised from the share offering is proportional to the appreciation of the investment property.

Server system 112 is configured to determine a proceeds amount (i.e., an amount of money raised) from the share offering based on the investment requests received in connection with the share offering. Determining a proceeds amount may include, for example, multiplying the number of shares sold during the share offering by the respective price per share. Server system 112 may update a project record 554 associated with the real estate project with the determined proceeds amount.

Server system 112 is configured to determine a compensation amount to be paid to shareholders of a real estate project based on at least one of the proceeds amount of the share offering, a number of shares owned by the shareholder, and/or a number of shares of the real estate project sold by the shareholder as a result of the share offering.

In one embodiment, server system 112 determines a compensation amount owed to a shareholder, such as investor 510, by determining a dividend amount for each share of the real estate project, and multiplying the number of shares owned by the shareholder by the dividend amount. For example, a project record 554 associated with the real estate project may include an entry for the total number of outstanding primary shares for the real estate project prior to the share offering. Server system 112 may determine a dividend amount by dividing the proceeds amount by the total number of primary shares. Server system 112 may then determine a compensation amount owed to the shareholder by multiplying the dividend amount by the number of shares owned by the shareholder. The number of shares owned by the shareholder may be stored, for example, in an investor account 584 associated with the shareholder.

In another embodiment, server system 112 may determine a compensation amount owed to a shareholder based on the appreciation of the underlying investment property associated with the real estate project. For example, as noted above, a project record 554 associated with the real estate project may include an entry associated with the appreciation of the investment property. Server system 112 may determine a dividend amount based on the appreciation of the investment property such that shareholders of the real estate project receive a cash dividend proportional to the appreciation of the underlying investment property. Server system 112 thereby enables such shareholders to realize the appreciation on investment properties in the form of cash dividends without the project sponsor having to sell or dispose of the investment property.

In another embodiment, server system 112 may determine a compensation amount owed to a shareholder based on a number of the shareholder's shares sold as the result of the share offering. For example, a shareholder may submit a request to server system 112 indicating a number of shares the shareholder desires to sell. The request may also include a minimum price that the shareholder is willing to accept for the shares. Server system 112 may fulfill all or a portion of the shareholder's request based on the amount of proceeds raised from the share offering and the total number of shares offered for sale by other shareholders during the share offering. Server system 112 may determine a compensation amount for the shareholder based on the amount of proceeds raised from the share offering, the number of the shareholder's shares sold as a result of the share offering, and the price per share at which the shares were sold.

Server system 112 may store the compensation amount owed to a shareholder in a project record 554 associated with the real estate project and/or an investor account 584 associated with the shareholder. Server system 112 may be further configured to transmit the compensation amount to a financial institution associated with the project sponsor and/or the shareholder to facilitate payment of the compensation amount to the shareholder.

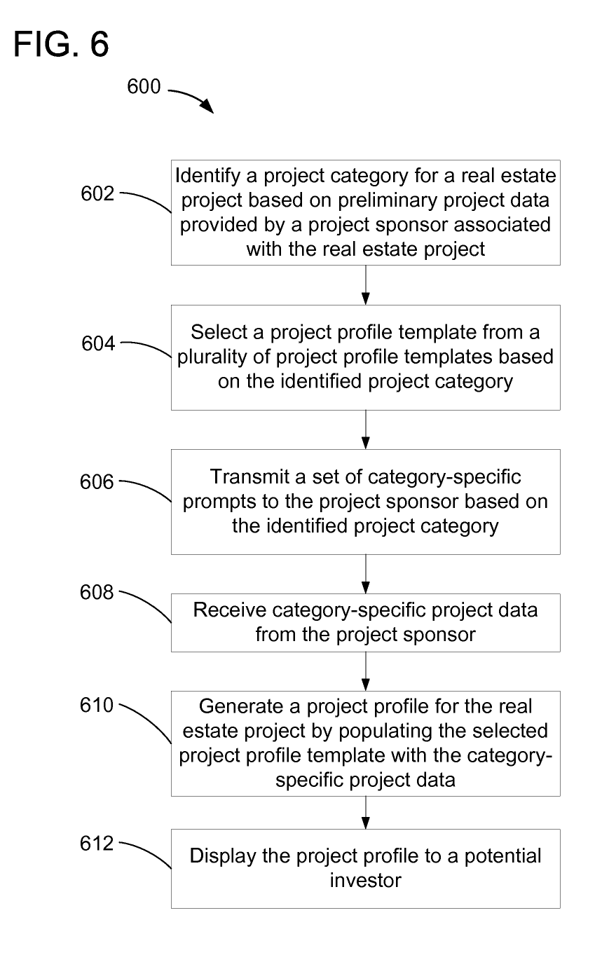

FIG. 6 is an example method 600 of soliciting financing for real estate projects in an online real estate project financing environment, such as online real estate project financing environment 500 shown in FIG. 5. In the example embodiment, method 600 is performed by a server system, such as server system 112 (shown in FIGS. 2 and 5).

In the example embodiment, method 600 includes identifying 602 a project category for a real estate project based on preliminary project data provided by a project sponsor associated with the real estate project. In some embodiments, the method may further include receiving the preliminary project from the project sponsor. Further, in some embodiments, the real estate project may be associated with an investment property, and the preliminary project data may include at least one of a target financing amount, location data associated with the investment property, a property value of the investment property, and an intended use of the investment property. Method 600 also includes selecting 604 a project profile template from a plurality of project profile templates based on the identified project category, where each project profile template associated with one of a plurality of project categories. In some embodiments, the project categories include an industrial category, a retail category, an office category, and a residential category.

Further, method 600 also includes transmitting 606 a set of category-specific prompts to the project sponsor based on the identified project category. The set of category-specific prompts is one of a plurality of sets of category-specific prompts, wherein each set is associated with one of the project categories. Method 600 also includes receiving 608 category-specific project data from the project sponsor. In some embodiments, the real estate project is associated with an investment property, and the category-specific project data includes information related to physical and financial characteristics of the investment property.

Method 600 also includes generating 610 a project profile for the real estate project by populating the selected project profile template with the category-specific project data. In some embodiments, the project profile is one of a plurality of project profiles, wherein each project profile is associated with one of the project categories, and project profiles associated with the same project category are generated using the same project profile template to facilitate comparison of real estate projects within the same category. Method 600 also includes displaying 612 the project profile to a potential investor. In some embodiments, the category-specific project data may include confidential information and non-confidential information. In such embodiments, displaying 612 the project profile may further include displaying a first view of the project profile if the potential investor is an unauthorized potential investor, wherein the first view includes only non-confidential information, and displaying a second view of the project profile if the potential investor is an authorized potential investor, wherein the second view includes confidential information and non-confidential information.

In some embodiments, method 600 may also include receiving an investment request from the potential investor to invest in the real estate project, wherein the investment request includes at least one of a number of shares to be purchased by the potential investor and a monetary value to be invested in the real estate project by the potential investor. Further, in some embodiments, method 600 may also include storing an investment document associated with the real estate project in the memory, populating the investment document with at least one of the number of shares to be purchased by the potential investor and the monetary value to be invested by the potential investor using the processor, and transmitting the investment document to the potential investor in response to the investment request.

In some embodiments, method 600 may also include transmitting a prompt to the project sponsor to provide project structure information associated with the real estate project including a selection of a business entity type for the project, a target financing amount for the project, and a number of shares available for purchase, and receiving the project structure information from the project sponsor. Further, in such embodiments, generating 610 the project profile may include populating the project profile template with the project structure information.

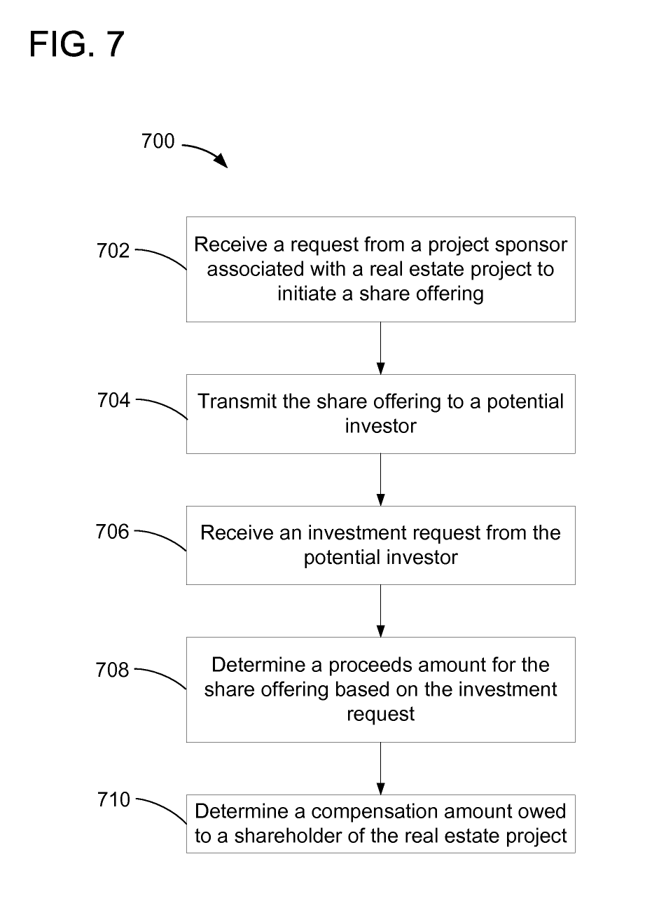

FIG. 7 is an example method 700 for providing liquidity to shareholders of a real estate project in an online real estate project financing environment, such as online real estate project financing environment 500 shown in FIG. 5. In the example embodiment, method 700 is performed by a server system, such as server system 112 (shown in FIGS. 2 and 5).

In the example embodiment, method 700 includes receiving 702 a request from a project sponsor associated with the real estate project to initiate a share offering. The request includes at least one of a number of shares of the real estate project to be offered for sale and a price per share. Method 700 also includes transmitting 704 the share offering to a potential investor. In some embodiments, the real estate project may be associated with a project category, and method 700 may further include storing a project profile associated with the real estate project in the memory, prompting the project sponsor for project performance data, wherein prompting the project sponsor includes transmitting a set of category specific prompts to the project sponsor based on the project category, receiving project performance data from the project sponsor, and generating an updated project profile using the project performance data. In such embodiments, transmitting 704 the share offering may include transmitting the updated project profile to the potential investor. Further, in such embodiments, generating an updated project profile may include selecting a project profile template associated with the project category from a plurality of project profile templates, wherein each project profile template is associated with one of a plurality of project categories, and populating the project profile template with the project performance data.

Method 700 also includes receiving 706 an investment request from the potential investor. In some embodiments, the investment request may be one of a plurality of investment requests, where each investment request includes a maximum price per share, and method 700 may further include determining a price per share for shares of the real estate project offered for sale in the share offering based on the maximum price per share from each investment request.

Method 700 also includes determining 708 a proceeds amount for the share offering based on the investment request. Method 700 also includes determining 710 a compensation amount owed to a shareholder of the real estate project based on at least one of the proceeds amount, a number of shares of the real estate project owned by the shareholder, and a number of shares of the real estate project sold by the shareholder as a result of the share offering. In some embodiments, method 700 may also include storing the compensation amount in the memory, and transmitting the compensation amount to a financial institution associated with one of the project sponsor and the shareholder to facilitate payment of the compensation amount to the shareholder.

In some embodiments, method 700 may also include receiving, prior to receiving the request to initiate the share offering, a message from the potential investor indicating that the potential investor desires to invest in the real estate project, and transmitting the message to the project sponsor. Further, in such embodiments, method 700 may also include receiving, prior to receiving the request to initiate the share offering, a message from the shareholder indicating that the shareholder desires to liquidate at least a portion of the shares of the real estate project owned by the shareholder, and transmitting the message to the project sponsor.

In some embodiments, method 700 may also include storing a project record associated with the real estate project, where the project record includes an entry associated with a total number of outstanding primary shares of the real estate project. Shares owned by the shareholder are primary shares, and the shares offered for sale in the share offering are secondary shares. In such embodiments, determining 710 a compensation amount may include determining a dividend amount for each primary share based on the proceeds amount and the total number of outstanding primary shares. Further, in such embodiments, the real estate project may be associated with an investment property, the project record may include an entry associated with a current value for the investment property, and determining a dividend amount may include determining a dividend amount based on the current value of the investment property. In some embodiments, method 700 may also include receiving a request from the shareholder indicating a number of shares of the real estate project the shareholder desires to sell.

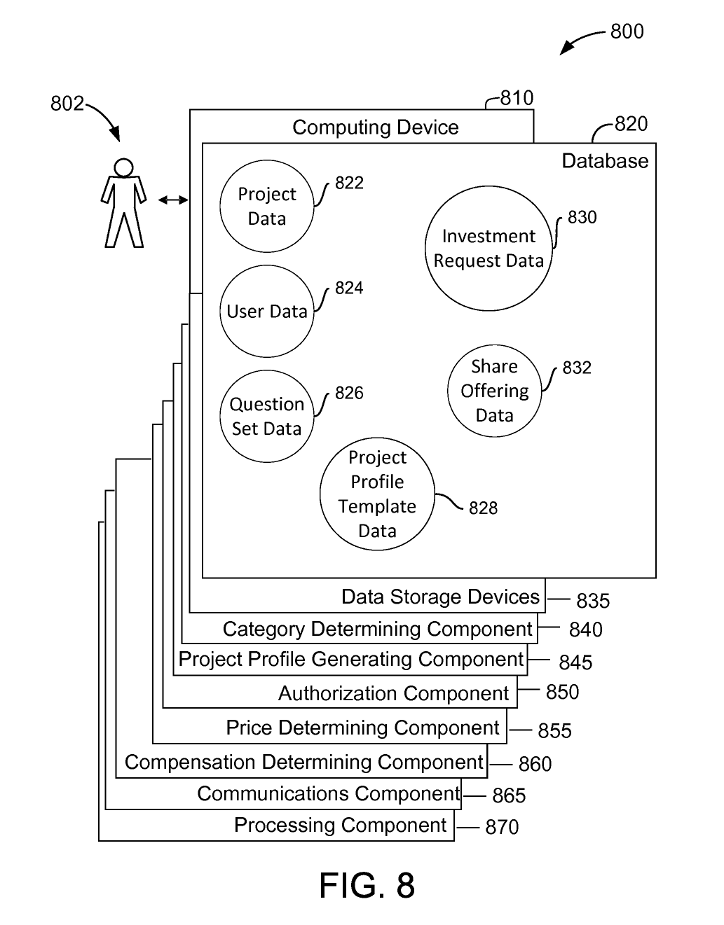

FIG. 8 shows an example configuration 800 of a database 820 within a computing device 810, along with other related computing components, that may be used to carry out the methods described herein. In some embodiments, computing device 810 is similar to server system 112 (shown in FIGS. 2 and 5), server computing device 402 (shown in FIG. 4), data management system 512 (shown in FIG. 5), and/or user access system 514 (shown in FIG. 5). Database 820 is coupled to several separate components within computing device 810, which perform specific tasks.

In the example embodiment, database 820 includes project data 822, user data 824, prompt set data 826, project profile template data 828, investment request data 830, and share offering data 832. Project data 822 includes information associated with a real estate project, and may include, for example, preliminary project data 552, project records 554, category-specific project data 562, project structure information 566, investment documents 568, project profiles 578, and project performance data 596 (all shown in FIG. 5). User data 824 includes information associated with users 802 of computing device 810, such as project sponsors 502, potential investors 504 and 586, investors 510, and third-party professionals 570 (all shown in FIG. 5). User data 824 may include, for example, project sponsor accounts 556 and investor accounts 584 (both shown in FIG. 5). Prompt set data 826 includes information associated with prompt sets 558 (shown in FIG. 5), including, for example prompt sets 558 and category-specific prompt. Project profile template data 828 includes information associated with project profile templates 580 (shown in FIG. 5), including, for example, project profile templates 580. Investment request data 830 includes information associated with investment requests 592 (shown in FIG. 5), including, for example, a number of shares to be purchased by a potential investor, a monetary value to be invested by a potential investor, and a maximum price per share a potential investor is willing to pay per share. Share offering data 832 includes information associated with share offerings, such as a number of shares available for purchase and a price per share.

Computing device 810 includes the database 820, as well as data storage devices 835. Computing device 810 also includes a category determining component 840 for determining and assigning project categories to real estate projects. Computing device 810 also includes a project profile generating component 845 for generating project profiles for real estate projects using project profile templates. Computing device 810 also includes an authorization component 850 for determining if users of computing device 810 are authorized and/or verified investors. Authorization component 850 may also be configured to process authorization requests and verification requests to authorize and verify users of computing device 810. Computing device 810 also includes a price determining component 855 for determining a price per share of a real estate project being financed and/or for determining a price per share for shares being offered in a share offering. Computing device 810 also includes a compensation determining component 860 for determining a compensation amount owed to shareholders of a real estate project. A communications component 865 is also included for receiving and transmitting information to and from users 802 of computing device 810. A processing component 870 assists with execution of computer-executable instructions associated with the system.

As will be appreciated based on the foregoing specification, the above-described embodiments of the disclosure may be implemented using computer programming or engineering techniques including computer software, firmware, hardware or any combination or subset thereof. Any such resulting program, having computer-readable code means, may be embodied or provided within one or more non-transitory computer-readable media, thereby making a computer program product, i.e., an article of manufacture, according to the discussed embodiments of the disclosure. The computer-readable media may be, for example, but is not limited to, a fixed (hard) drive, diskette, optical disk, magnetic tape, semiconductor memory such as read-only memory (ROM), and/or any transmitting/receiving medium such as the Internet or other communication network or link. The article of manufacture containing the computer code may be made and/or used by executing the code directly from one medium, by copying the code from one medium to another medium, or by transmitting the code over a network.

These computer programs (also known as programs, software, software applications, “apps”, or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The “machine-readable medium” and “computer-readable medium,” however, do not include transitory signals. The term “machine-readable signal” refers to any signal used to provide machine instructions and/or data to a programmable processor.

As used herein, the term “non-transitory computer-readable media” is intended to be representative of any tangible computer-based device implemented in any method or technology for short-term and long-term storage of information, such as, computer-readable instructions, data structures, program modules and sub-modules, or other data in any device. Therefore, the methods described herein may be encoded as executable instructions embodied in a tangible, non-transitory, computer readable medium, including, without limitation, a storage device and/or a memory device. Such instructions, when executed by a processor, cause the processor to perform at least a portion of the methods described herein. Moreover, as used herein, the term “non-transitory computer-readable media” includes all tangible, computer-readable media, including, without limitation, non-transitory computer storage devices, including, without limitation, volatile and nonvolatile media, and removable and non-removable media such as a firmware, physical and virtual storage, CD-ROMs, DVDs, and any other digital source such as a network or the Internet, as well as yet to be developed digital means, with the sole exception being a transitory, propagating signal.

This written description uses examples, including the best mode, to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A system for soliciting financing for real estate projects, said system comprising:
at least one processor communicatively coupled to at least one memory;
a data management system communicatively coupled to the at least one processor and the at least one memory; and
a user access system communicatively coupled to the at least one processor and the at least one memory, wherein the data management system is configured to:
identify a project category for a real estate project based on preliminary project data provided by a project sponsor associated with the real estate project;
select a project profile template from a plurality of project profile templates stored in the at least one memory based on the identified project category, each project profile template associated with one of a plurality of project categories;
transmit a set of category-specific prompts to the project sponsor based on the identified project category, wherein the set is one of a plurality of sets of category-specific prompts stored in the at least one memory, each set associated with one of the project categories;
receive category-specific project data from the project sponsor; and
generate a project profile for the real estate project by populating the selected project profile template with the category-specific project data using the at least one processor; and
wherein the user access system is configured to display the project profile to a potential investor.

2. The system of claim 1, wherein the data management system is further configured to generate a plurality of project profiles, each project profile being associated with one of the project categories, wherein project profiles associated with the same project category are generated using the same project profile template to facilitate comparison of real estate projects within the same category.

3. The system of claim 1, wherein the user access system is further configured to:
receive an investment request from the potential investor to invest in the real estate project; and
transmit the investment request to the data management system; and
wherein the data management system is further configured to:
store an investment document associated with the real estate project in the at least one memory; and
transmit the investment document to the user access system in response to the investment request.

4. The system of claim 3, wherein the investment request includes at least one of a number of shares to be purchased by the potential investor and a monetary value to be invested in the real estate project by the potential investor, and the data management system is further configured to populate the investment document with at least one of the number of shares and the monetary value.

5. The system of claim 1, wherein the data management system is further configured to:
receive project structure information associated with the real estate project from the project sponsor, the project structure information including a selection of a business entity type for the project, a target financing amount for the project, and a number of shares available for purchase; and
generate the project profile by populating the project profile template with the project structure information.

6. The system of claim 1, wherein the category-specific project data includes confidential information and non-confidential information, and wherein the user access system is configured to display the project profile to the potential investor by:
displaying a first view of the project profile if the potential investor is an unauthorized potential investor, wherein the first view includes only non-confidential information; and
displaying a second view of the project profile if the potential investor is an authorized potential investor, wherein the second view includes confidential information and non-confidential information.

7. The system of claim 6, wherein the user access system is further configured to:
receive a request from the potential investor to view the project profile;
transmit an authorization inquiry to the data management system to determine if the potential investor is an authorized potential investor or an unauthorized potential investor;
receive an authorization message from the data management system indicating that the potential investor is an unauthorized investor or an authorized investor; and
display one of the first view and the second view of the project profile based on the authorization message.

8. A computer-based method for soliciting financing for real estate projects, the method implemented using a computing device including at least one processor communicatively coupled to at least one memory, a data management system communicatively coupled to the at least one processor and the at least one memory, and a user access system communicatively coupled to the at least one processor and the at least one memory, said method comprising:
identifying, using the data management system, a project category for a real estate project based on preliminary project data provided by a project sponsor associated with the real estate project;
selecting, using the data management system, a project profile template from a plurality of project profile templates stored in the at least one memory based on the identified project category, each project profile template associated with one of a plurality of project categories;
transmitting, using the data management system, a set of category-specific prompts to the project sponsor based on the identified project category, wherein the set is one of a plurality of sets of category-specific prompts stored in the at least one memory, each set associated with one of the project categories;
receiving, at the data management system, category-specific project data from the project sponsor;
generating, using the data management system, a project profile for the real estate project by populating the selected project profile template with the category-specific project data using the at least one processor; and
displaying, using the user access system, the project profile to a potential investor.

9. The method of claim 8, wherein the project profile is one of a plurality of project profiles stored in the at least one memory, each project profile being associated with one of the project categories, wherein project profiles associated with the same project category are generated using the same project profile template to facilitate comparison of real estate projects within the same category.

10. The method of claim 8 further comprising:
receiving, at the user access system, an investment request from the potential investor to invest in the real estate project;
transmitting the investment request to the data management system;
storing, using the data management system, an investment document associated with the real estate project in the at least one memory; and
transmitting the investment document to the user access system in response to the investment request.

11. The method of claim 10, wherein investment request includes at least one of a number of shares to be purchased by the potential investor and a monetary value to be invested in the real estate project by the potential investor, the method further comprising populating, using the data management system, the investment document with at least one of the number of shares and the monetary value.

12. The method of claim 10 further comprising:
receiving, at the data management system, project structure information associated with the real estate project from the project sponsor, the project structure information including a selection of a business entity type for the project, a target financing amount for the project, and a number of shares available for purchase; and
wherein generating the project profile further comprises populating the project profile template with the project structure information.

13. The method of claim 10, wherein the category-specific project data includes confidential information and non-confidential information, wherein displaying the project profile further comprises:
displaying, using the user access system, a first view of the project profile if the potential investor is an unauthorized potential investor, wherein the first view includes only non-confidential information; and
displaying, using the user access system, a second view of the project profile if the potential investor is an authorized potential investor, wherein the second view includes confidential information and non-confidential information.

14. The method of claim 13, further comprising:
receiving, at the user access system, a request from the potential investor to view the project profile;
transmitting an authorization inquiry to the data management system to determine if the potential investor is an authorized potential investor or an unauthorized potential investor;
receiving, at the user access system, an authorization message from the data management system indicating that the potential investor is an unauthorized investor or an authorized investor; and
displaying, using the user access system, one of the first view and the second view of the project profile based on the authorization message.

15. At least one non-transitory computer-readable storage media having computer-executable instructions embodied thereon, wherein when executed by at least one processor communicatively coupled to a data management system and a user access system, the computer-executable instructions cause the data management system to:
identify a project category for a real estate project based on preliminary project data provided by a project sponsor associated with the real estate project;
select a project profile template from a plurality of project profile templates based on the identified project category, each project profile template associated with one of a plurality of project categories;
transmit a set of category-specific prompts to the project sponsor based on the identified project category, wherein the set is one of a plurality of sets of category-specific prompts, each set associated with one of the project categories;
receive category-specific project data from the project sponsor; and
generate a project profile for the real estate project by populating the selected project profile template with the category-specific project data using the at least one processor; and
wherein the computer executable instructions cause the user access system to display the project profile to a potential investor.

16. The computer-readable storage media of claim 15, wherein the computer-executable instructions further cause the data management system to generate a plurality of project profiles, each project profile being associated with one of the project categories, wherein project profiles associated with the same project category are generated using the same project profile template to facilitate comparison of real estate projects within the same category.

17. The computer-readable storage media of claim 15, wherein the computer-executable instructions further cause the user access system to:
receive an investment request from the potential investor to invest in the real estate project; and
transmit the investment request to the data management system; and
wherein the computer-executable instructions further cause the data management system to:
store an investment document associated with the real estate project; and
transmit the investment document to the user access system in response to the investment request.

18. The computer-readable storage media of claim 17, wherein the investment request includes at least one of a number of shares to be purchased by the potential investor and a monetary value to be invested in the real estate project by the potential investor, and wherein the computer-executable instructions further cause the data management system to populate the investment document with at least one of the number of shares and the monetary value.

19. The computer-readable storage media of claim 15, wherein the computer-executable instructions further cause the data management system to:
receive project structure information associated with the real estate project from the project sponsor, the project structure information including a selection of a business entity type for the project, a target financing amount for the project, and a number of shares available for purchase; and
generate the project profile by populating the project profile template with the project structure information.

20. The computer-readable storage media of claim 15, wherein the category-specific project data includes confidential information and non-confidential information, and wherein the computer-executable instructions further cause the user access system to display the project profile to the potential investor by:
displaying a first view of the project profile if the potential investor is an unauthorized potential investor, wherein the first view includes only non-confidential information; and
displaying a second view of the project profile if the potential investor is an authorized potential investor, wherein the second view includes confidential information and non-confidential information.
